(19) United States
(12) Patent Application Publication
(10) Pub. No.: US 2024/0144595 A1
(43) Pub. Date: May 2, 2024

(54) 3D SCENE RECONSTRUCTION WITH ADDITIONAL SCENE ATTRIBUTES

(71) Applicant: STREEM, LLC, Portland, OR (US)

(72) Inventor: Flora PONJOU TASSE, Portland, OR (US)

(73) Assignee: STREEM, LLC, Portland, OR (US)

(21) Appl. No.: 17/974,004

(22) Filed: Oct. 26, 2022

(51) Int. Cl. G06T 17/20; G06T 7/11; G06T 7/55; G06T 19/20; G06V 10/26; G06V 20/64

(52) U.S. Cl. CPC G06T 17/20; G06T 7/11; G06T 7/55; G06T 19/20; G06V 10/26; G06V 20/64; G06T 2207/10028; G06T 2207/20084; G06T 2215/16; G06T 2219/2016

(57) ABSTRACT

A neural network architecture is provided for reconstructing, in real-time, a 3D scene with additional attributes such as color and segmentation, from a stream of camera-tracked RGB images. The neural network can include a number of modules which process image data in sequence. In an example implementation, the processing can include capturing frames of color data, selecting key frames, processing a set of key frames to obtain partial 3D scene data, including a mesh model and associated voxels, fusing the partial 3D scene data into existing scene data, and extracting a 3D colored and segmented mesh from the 3D scene data.

### TECHNICAL FIELD

The present disclosure relates to the field of photogrammetry, and specifically to the generation of a model of a three-dimensional (3D) space from captured images.

### BACKGROUND

Devices such as smartphones and tablets are increasingly capable of measuring and/or computing depth data of images or videos they capture, which in turn are useful for supporting augmented reality (AR) and/or other applications involving 3D spaces. These captured images or video and derived or captured depth data may be processed using various algorithms to detect features in the video, such as planes, surfaces, faces, and other recognizable shapes. These detected features, combined in some implementations with data from depth sensors and/or motion information captured from motion sensors such as a Micro-Electro-Mechanical System (MEMS) gyroscope and accelerometers, can be used by software in creating a point cloud in a 3D space. A 3D mesh representation of the point cloud can in turn be obtained to represent the 3D space more efficiently. The 3D mesh include vertices and faces which represents boundaries of real objects in the 3D space. The point cloud or 3D mesh enables operations such as measurements of physical dimensions of the real objects.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a block diagram of the components of a system for capturing an image and corresponding augmented reality (AR) data, according to various embodiments.

FIG. 2A depicts an example high-level process flow for generating a 3D mesh and virtual reconstruction from a captured video and associated AR data, according to various embodiments.

FIG. 2B depicts an example set of video frames 250 in which selected frames 251 and 257 are key frames, according to various embodiments.

FIG. 3 is a flowchart of the operations of an example method for processing frames of RGB color data to obtain 3D scene data, color data and segmentation data, according to various embodiments.

FIG. 4 depicts an example set of modules 450 for implementing operations 306, 308 and 310 of the method of FIG. 3, according to various embodiments.

FIG. 5 depicts an example implementation of any of the modules of FIG. 4 as a neural network 500, according to various embodiments.

FIG. 6 depicts an example system 600 for implementing some of the modules of FIG. 4, according to various embodiments.

FIG. 7A depicts an example implementation of an unprojection process for use in the module 405 of FIG. 4, according to various embodiments.

FIG. 7B depicts an example of the fusion of multiple sparse volumes extracted from different images in a fragment, consistent with module 410 of FIG. 4, according to various embodiments.

FIG. 7C depicts an example implementation of a GRU fusion process consistent with FIG. 6 and the output from FIG. 7A, according to various embodiments.

FIG. 8A depicts an example of a set of voxels with truncated signed distance function (TSDF) values for use in the module 426 of FIG. 4, according to various embodiments.

FIG. 8B depicts an example of a sparse 3D mask 860 which indicates a probability of whether a voxel belongs to the surface of a mesh, consistent with FIG. 8A, according to various embodiments.

FIG. 8C depicts an example of a set of voxels with color and segmentation information, consistent with FIG. 8A, according to various embodiments.

FIG. 9 depicts an example view of a 3D space 900 for use with the method of FIG. 3, according to various embodiments.

FIG. 10 depicts another example view of the 3D space 900 of FIG. 9, according to various embodiments.

FIG. 11 depicts a top down view of the 3D space 900 of FIG. 9, according to various embodiments.

FIG. 12A depicts example sparse 3D point clouds 1240 and 1250 consistent with the view of FIG. 9, according to various embodiments.

FIG. 12B depicts an example mesh model 1242 corresponding to the portion 1241 of the sparse 3D point cloud 1240 of FIG. 12A, according to various embodiments.

FIG. 13 depicts example sets of voxels 1340 and 1350 which encompass the points of the sparse 3D point clouds 1240 and 1250 of FIG. 12A, respectively, according to various embodiments.

FIG. 14 depicts the combining or fusing of two fragments 1410 and 1420 which represent two areas of a 3D space, consistent with the module 422 of FIG. 4, according to various embodiments.

FIG. 15 depicts a fully reconstructed image 1500 of a 3D space, according to various embodiments.

FIG. 16 is a block diagram of an example computer that can be used to implement some or all of the components of the disclosed systems and methods, according to various embodiments.

FIG. 17 is a block diagram of a computer-readable storage medium that can be used to implement some of the components of the system or methods disclosed herein, according to various embodiments.

### DETAILED DESCRIPTION OF DISCLOSED EMBODIMENTS

In the following detailed description, reference is made to the accompanying drawings which form a part hereof, and in which are shown byway of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Technologies which can obtain a 3D digital replica of a physical space/scene enable a number of possible applications such as augmented reality (AR), remote customer support, remodeling or redecorating of a space and so forth. The 3D replica represents objects in the space based on their position relative to a capturing device such as a camera of a mobile device such as a smart phone or tablet.

One aspect of the position involves the depth. Some modern smart phones and tablets have built in depth sensors such as Light Detection and Ranging (LiDAR) sensors to directly capture depth data and use it to create a replica of the space. However, this capability is not always present and, worldwide, the majority of such devices on the market do not have such a capability.

Another approach to capturing depth data involves stereoscopic cameras. However, these are not common in portable devices such as smart phones and tablets.

A camera which does not have a depth sensor is referred to as a simple camera or a monocular vision camera.

It would be desirable to create a real-time 3D replica of a physical space using a simple camera and the RGB color images it captures This process is referred to as real-time 3D scene reconstruction from RGB images.

One possible solution involves 3D machine learning which includes neural networks that incrementally take in a set of camera-tracked RGB images, and output a 3D mesh model of a space. The 3D mesh model may be composed of vertex positions, face indices, and vertex normals. Another possible solution uses machine learning to reconstruct a 3D scene from a single image. However, this is not suitable for reconstructing a full 3D space such as a room with furniture since the space is not captured from different perspectives.

It would be desirable to improve on these techniques by providing a 3D replica of a physical space with additional voxel attributes such colors and semantic segmentation labels in the output.

The techniques described herein address the above and other issues. In one aspect, a neural network architecture is provided for reconstructing, in real-time, a 3D scene with additional attributes such as color and segmentation, from a stream of camera-tracked RGB images. The neural network can include a number of modules which process image data in sequence. In an example implementation, the processing can include capturing frames of color data, selecting key frames, processing a set of key frames to obtain partial 3D scene data, including a mesh model and associated voxels, fusing the partial 3D scene data into existing scene data, and extracting a 3D colored and segmented mesh from the 3D scene data.

The above and other benefits will be further understood in view of the following.

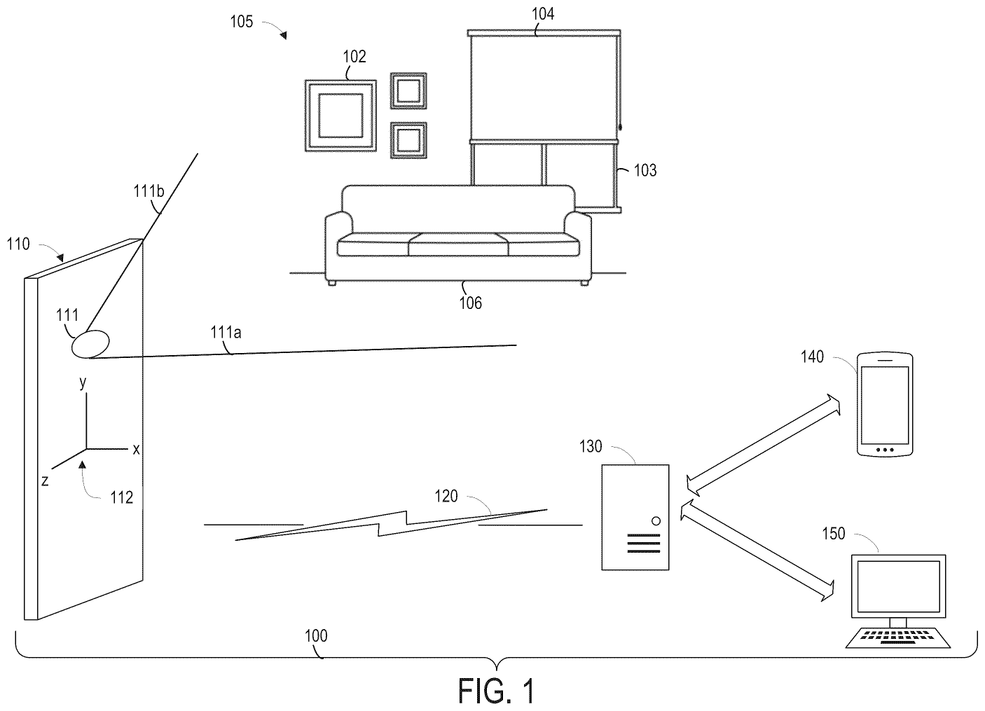

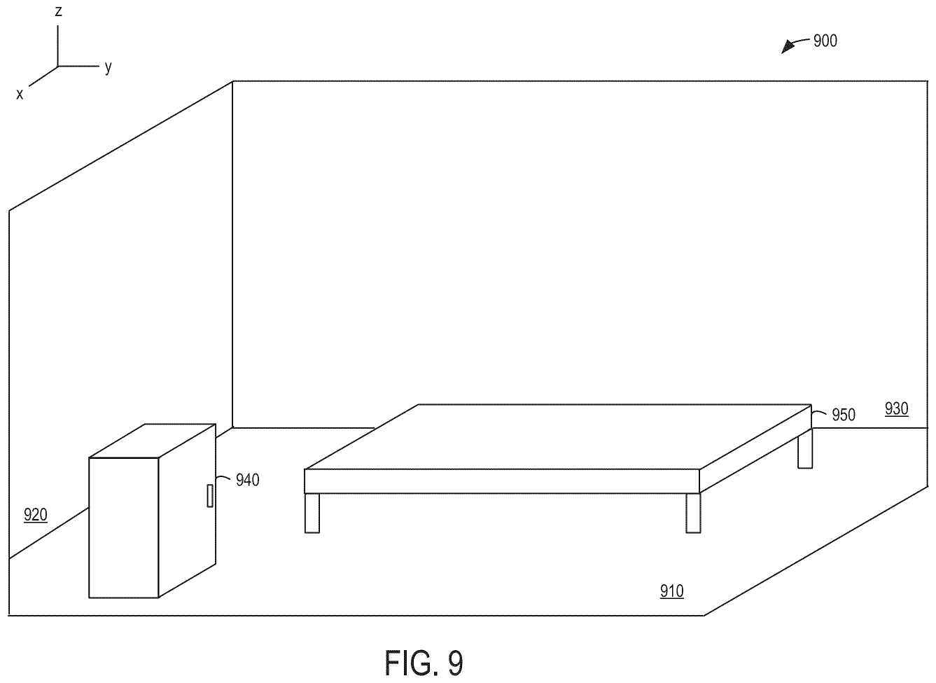

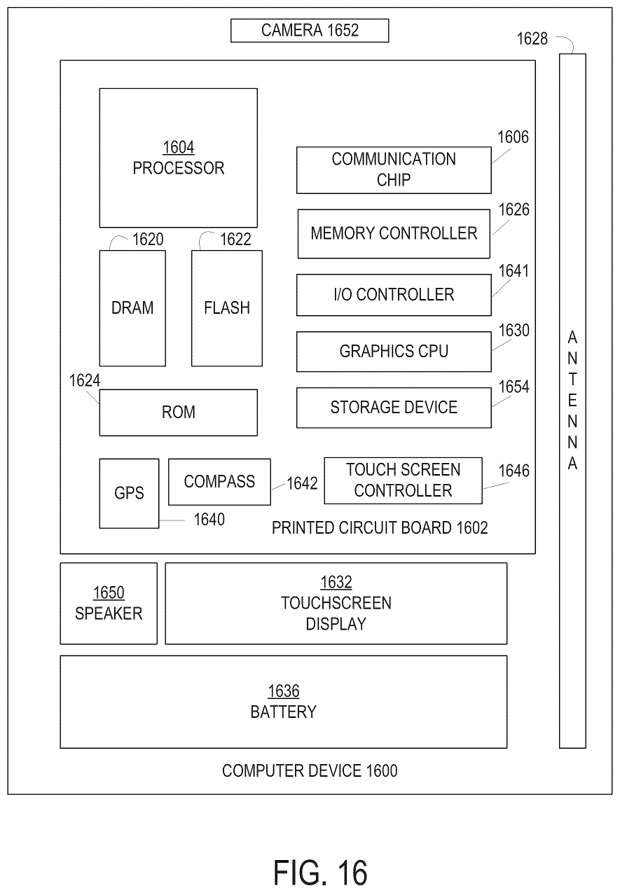

FIG. 1 illustrates a block diagram of the components of a system 100 for capturing an image and corresponding AR data, according to various embodiments. The system 100 may include a user device 110, e.g., a capturing device, such as a smartphone, tablet, desktop or laptop computer, two-in-one (a portable computer that includes features of both tablets and laptops), hybrid, wearable computer such as smart glasses or a smartwatch, or any other computing device that can accept a camera and provide positional information, as will be discussed in greater detail herein. The device may be implemented as a computer device 1600 such as discussed in connection with FIG. 16. User device 110 further may include a camera 111 and a spatial position sensor 112 (depicted by a series of axes), which provides information about the spatial position of camera 111. It will be understood that camera 111 and spatial position sensor 112 may be contained within the body of device 110, as depicted in this example. Camera 111 is used to capture the surrounding environment of device 110, and by extension, the user. The camera can capture images of the space 105 within a field of view represented by boundary lines 111a and 111b. The environment may be a 3D space 105 such as a room, and may include one or more three-dimensional objects. In this example, the 3D space is a room which includes objects such as a framed picture 102 (e.g., a wall hanging), a window 103, a shade 104 for the window and a sofa 106. Other examples of 3D spaces are provided further below including, e.g., in FIG. 9-11.

Camera 111 may be any camera that can provide a suitable video stream for the intended purpose of user device 110. The camera may be a monocular vision camera, e.g., a camera which operates in a monocular vision mode without a depth data sensor. Where user device 110 is implemented as a smartphone or tablet, camera 111 may be one or more built-in cameras. In other embodiments, such as where user device 110 is a laptop, camera 111 may be built in or may be a separate, external unit. A suitable video stream may be a digital video stream, and may be compressed in embodiments using Advanced Video Codec High Definition (AVC-HD), H.264 (also known as MPEG-4 Part 10, Advanced Video Coding), MPEG-4, or another suitable compression scheme. Camera 111 may be configured to output standard or high-definition video, 4K video, or another resolution of video suitable for the intended purpose of camera 111 and user device 110. In other embodiments, the camera 111 of user device 110 may comprise multiple cameras or similar sensors.

Spatial position sensor 112 may be configured to provide positional information about camera 111, such as the cameras pan and tilt. Other measured positional vectors may include camera movements, such as the camera rising or falling, or moving laterally. Spatial position sensor 112 may be implemented with micro or MEMS sensors, such as gyroscopes to measure angular movements and accelerometers to measure linear movements such as rises, falls, and lateral movements. In other embodiments, spatial position sensor 112 may be implemented using any suitable technology capable of measuring spatial movements of camera, including but not limited to depth sensors of the camera 111. In some embodiments, spatial position sensor 112 may comprise multiple sensors, each potentially measuring a different type of spatial position information, e.g. a 3-axis gyroscope to measure angular changes, a 3-axis accelerometer to measure velocity/translational changes, a magnetic compass to measure heading changes, a barometer to measure altitude changes, a GPS sensor to provide positional information, etc.

System 100 also includes a central server 130, with which user device 110 communicates via a communication channel 120. Central server 130 may act to receive information from user device 110 such as video data, which may be used with process flow 200 or method 300, discussed below. In some embodiments, user device 110 may handle processing of video information for a captured 3D space, including generation of a metaverse (a virtual-reality space in which users can interact with a computer-generated environment and other users), 3D mesh, and/or layout and estimation of measurements. However, depending upon the specifics of a given implementation, central server 130 may instead carry out some or all processing of the video data to generate a spatial layout and estimation of dimensions of a 3D space captured by the user device 110. User device 110 may either handle a part of the processing, or simply act to acquire data about a 3D space and provide raw or partially processed data to central server 130 for further processing.

Also shown in system 100 are one or more additional user devices 140 and 150, which may be smartphones, tablets, laptops, desktops, or other servers. These additional user devices 140 and 150 may also be in data communication with the central server 130, and so may receive raw or processed data captured by user device 110 and/or a completed layout and estimation of measurements of the 3D space captured by user device 110. User devices 140 and/or 150 may be capable of interaction with the layout and estimations, as well as a generated 3D mesh or metaverse, received from central server 130. Further still, user devices 140 and 150 may engage in two-way or multi-way interaction with user device 110 through central server 130, with each device commonly working with a generated 3D mesh, metaverse, 2D or 3D layout, and/or estimates of spatial dimensions of the metaverse. It should be understood that devices 140 and 150 are merely examples, and are not indicative of the number or type of devices connected to central server 130; a given implementation may have an arbitrary number of devices connected to central server 130.

User device 110, as mentioned above, is in data communication 120 with central server 130, along with user devices 140 and 150. Data communication 120 may be implemented using any suitable data communication link technology, which may be wired, wireless, or a combination of both. Example communications technologies are discussed below with respect to FIG. 16.

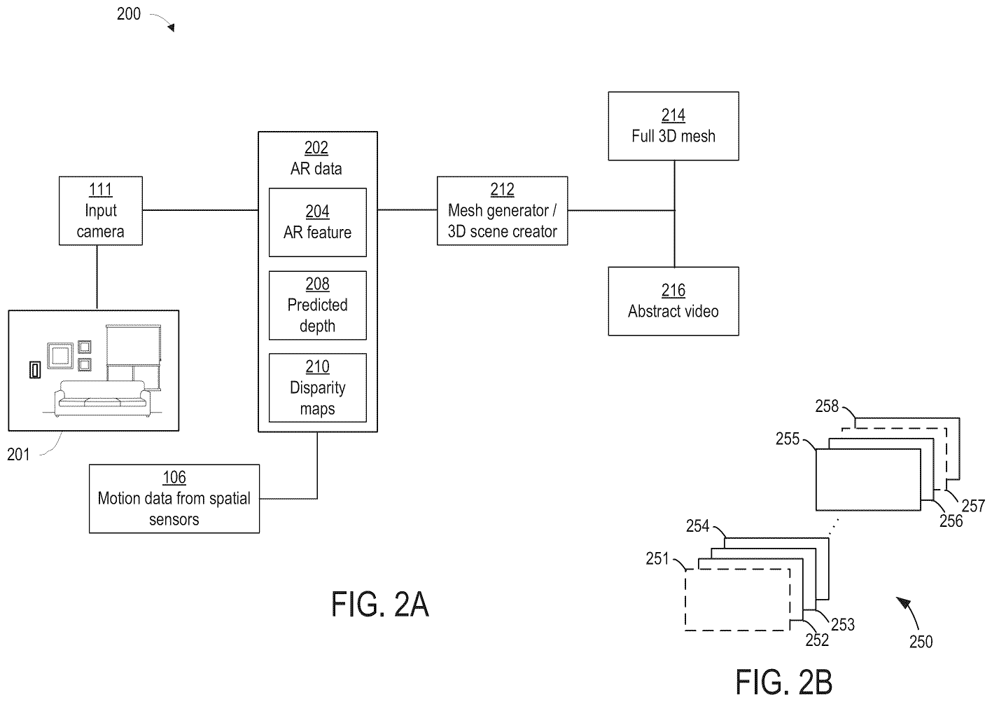

FIG. 2A depicts an example high-level process flow for generating a 3D mesh and virtual reconstruction from a captured video and associated AR data, according to various embodiments. Process flow 200 may be carried out by one or more components of the system 100, in various embodiments. Initially, a video 201, or one or more images, such as an image of the space 105 of FIG. 1, is captured by an input device, such as the camera 111, along with associated motion data (not depicted). This video 201 is then, in embodiments, partially or wholly processed by the AR application programming interface (API) of the capturing device to generate AR data 202, which may be tagged to the video 201. Examples of an AR API include ARKit, an augmented reality (AR) development platform for iOS mobile devices developed by Apple Inc., and ARCore, a platform for building augmented reality experiences developed by Google LLC.

Note that, as used herein, AR data 202 is not data about AR objects. Rather, AR data 202 includes point cloud data that corresponds to video 201 that may be useful to create a 3D mesh of the captured 3D space, as well as other useful analysis, such as plane detection and semantic segmentation. Furthermore, in some embodiments, the AR API of the capturing device may include semantic segmentation as part of AR data 202.

This AR data 202 may then be used to generate a layout and/or metaverse or virtual representation of the 3D space by a mesh generator/3D scene creator 212. Finally, the mesh and/or 3D scene can be used to generate a full 3D mesh 214, which includes one or more frames from the video 201 (and/or other sources of relevant images) mapped upon the 3D mesh 214 to generate a relatively realistic model. Additionally, an abstract video 216, which may comprise a layout or metaverse model of the scene captured by the camera 111, may be generated from the detected points in the point cloud. The model can then be used in an interactive fashion.

AR data 202 may be captured contemporaneously with and/or extracted from, video 201, and may be tagged to video 201. AR data 202 may include AR feature point data 204, motion data from spatial sensors 112 (shown in FIG. 1), predicted depth data 208, and/or disparity maps 210. Other embodiments may include additional data types, different data types, or fewer data types. The various types of AR data 202 may be derived from various raw data inputs, including Red-Green-Blue (RGB) images (such as the sequence of frames of video 201), intrinsic camera parameters and/or camera transform data (such as from camera 111 and/or spatial position sensor 112), and/or 3D feature points, among other types of possible data. RGB images may be extracted from frames of the video captured by camera 111. An RGB image defines red, green, and blue color components for each individual pixel of the image.

Intrinsic parameters of a camera are parameters that are internal and fixed to a particular camera. These parameters characterize the optical, geometric, and digital characteristics of the camera and may include: (1) the perspective projection (e.g., focal length), (2) the transformation between image plane coordinates and pixel coordinates, and (3) the geometric distortion introduced by the optics.

In addition to motion data from spatial position sensor 112, intrinsic camera parameters can include various known or readily determined properties of camera 111, such as focal length, aperture, optical center, angle of view, focal point, etc. For example, knowing the focal point of a camera can allow a rough approximation of distance (depth) to a feature when that feature is in focus. In some possible embodiments, the camera optics may be equipped with an encoder to indicate their focus position, which may be mapped to specific distances. Objects that are then detected as in focus can be understood to be approximately the distance from the camera of the focus position indicated by the encoder. Whether a feature is in focus may be determined by techniques such as edge detection or another contrast-based technique. However, it will be appreciated that, in some instances, only a range of possible depths or distances may be capable of being determined, such as where camera 111 is focused relatively far away from the camera position, and/or the camera 111 utilizes a small aperture (relatively high f-stop, such as f/8, f/11, etc.), so as to offer a large depth of field.

Camera transforms can include the various variables necessary to transform between the 3D objects within the field of view of camera 111 and the 2D image plane of the camera 111. Such variables can include information about the spatial location of the capturing device. 3D feature points can include feature points which can be used by the AR API to create the AR feature point data 204, and may be extracted from video 201, such as various anchor points or features, and/or captured using one or more sensors that are separate from video 201, such as spatial position sensor 112.

AR feature point data 204 can include data concerning or otherwise identifying various feature points in the captured scene that are identified by the AR API. These feature points may include anchor points corresponding to various identified features such as edges, points, planes, and other features detected via an object recognition algorithm or other suitable technique, and/or otherwise detected directly or indirectly by a sensor such as spatial position sensor 112 or a depth-sensitive device. Identified features including edges, points, and planes may be used to create a 2D or 3D layout and/or metaverse. Further, these feature points may correspond to segmented portions of the captured 3D scene, such as distinguishing a wall, window, picture, or other planar feature from identified planes such as walls, floor, ceiling, etc.

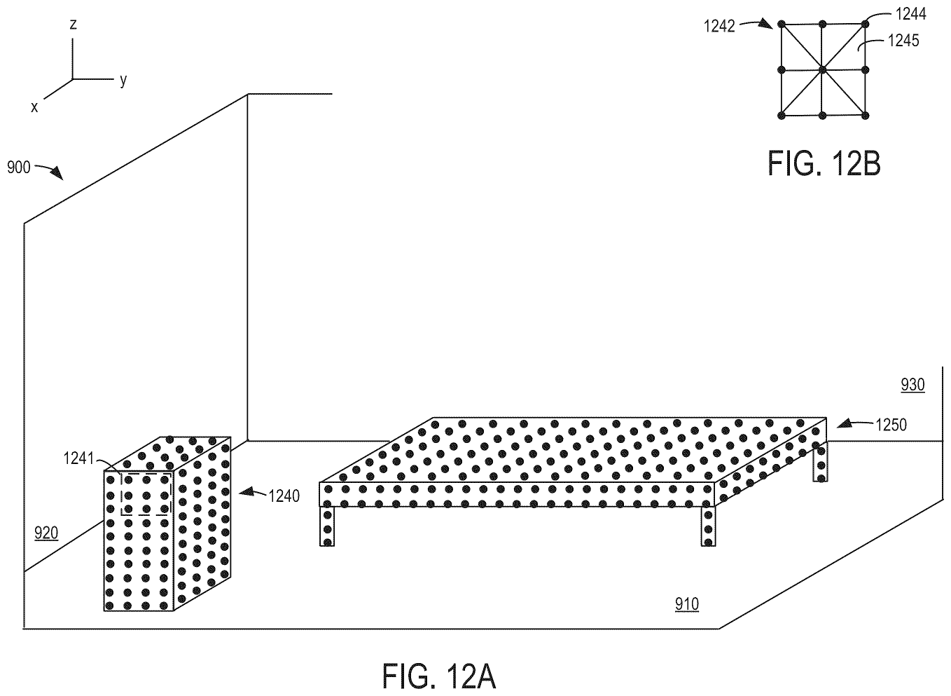

The AR API may derive predicted depth data 208 from techniques such as machine learning, and/or photogrammetry and comparison between proximate frames of the captured video. The predicted depth 208 may comprise a point cloud that, when interconnected, comprises a 3D mesh, with the points forming the vertices of the mesh polygons such as triangles. See, e.g., FIGS. 12A and 12B.

Similar to such comparison are disparity maps 210, which may include a map indicating the field of view differences between left/right frames in the case of a stereo camera, or proximate frames of the captured video. A disparity map 210 may be useful for computing points in the point cloud, including obtaining predicted depth data 208. It should be understood that proximate frames need not be temporally adjacent in video 201, but rather proximate in terms of field of view: two frames need only simply share at least an overlapping portion of a given scene to be considered proximate for purposes of a disparity map 210.

The mesh generator/3D scene creator 212 receives the AR data 202 and uses it to generate a 3D mesh, which may then be output as a full 3D mesh 214 and/or an abstract video 216, or layout and/or metaverse. The resulting output from the mesh generator/3D scene creator 212 can be a full 3D mesh 214, where the RGB image from various frames of video 201 are mapped onto a 3D mesh generated using the AR data. Such a process may be considered a type of texture mapping, where the RGB image of various frames are used as texture maps. The full 3D mesh 214 provides a geometric representation of the captured 3D space. The full 3D mesh 214 can be used for various purposes, such as simulating physical interactions with objects in the 3D space represented by the full 3D mesh 214, taking measurements of the represented environment, later exploration or walkthrough, or another suitable purpose.

An abstract video 216 can also be output, which may be or include a virtual representation such as a metaverse, and/or a 2D or 3D layout. As with the full 3D mesh 214, such a layout or virtual representation reflects the physical geometry of the captured 3D space, and may include measurements of the captured space that reflect the actual physical dimension of the captured 3D space. In this respect, the virtual representation/layout/metaverse is equivalent in physical dimensions to the captured 3D space, albeit as a digital representation.

It should be understood that, while the foregoing description and subsequent discussions assume that video 201 is in color, e.g. comprised of a plurality of frames that each include an RGB image, other image formats may be utilized. For example, the image data of each frame may instead be expressed using different color systems such as YUV, HSL (hue, saturation, lightness), CMYK (cyan, magenta, yellow, and key), or another method of expressing color, in alternative embodiments. In still other embodiments, the image information may comprise black and white or greyscale information, with no color information. Further still, other embodiments may utilize a combination of color and greyscale/black and white images.

FIG. 2B depicts an example set of video frames 250 in which selected frames 251 and 257 are key frames, according to various embodiments. Key frames are frames which contain relevant information which is not substantially redundant with previous frames. Key frames can have redundant information but also contain new information. For example, when obtaining video images of a 3D scene for use in generating a mesh model of the scene, key frames are frames which contain information which is helpful in generating the mesh model. Key frames are frames in which the camera/depth sensor sees the scene from different perspectives. A key frame can be selected when the camera/depth sensor looks at new area of a 3D space for the first time, or when the camera/depth sensor looks at an area which was already looked at, but from a better (closer) distance and better (more direct) point of view. For example, a frame can be selected as a key frame when the camera has made a significant movement, such as by moving by more than one meter or rotating by more than 20 degrees. When such a movement is detected, the next frame can be selected as a key frame.

By selecting a subset of all frames as key frames for use in generating the mesh model or other processing, and omitting other frames, the process is made more efficient.

In this example, a set of video frames 250 includes frames 251-258 and frames 251 and 257 are selected as key frames.

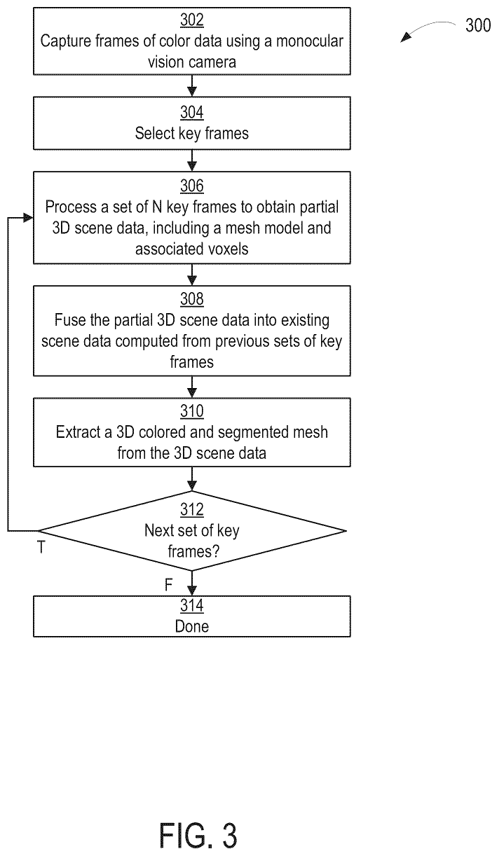

FIG. 3 is a flowchart of the operations of an example method for processing frames of RGB color data to obtain 3D scene data, color data and segmentation data, according to various embodiments. Various embodiments may implement some or all of the operations of method 300, and each of the operations of method 300 may be performed in whole or in part. Some embodiments may add or omit additional operations, or may change the order of operations as may be appropriate for a given implementation. Method 300 may be carried out in whole or in part by one or more components of system 100.

Generally, given a set of RGB images with corresponding camera poses, a goal is create, in real-time, a 3D mesh of the scene, with color information as well as segmentation information when applicable.

Operation 302 includes capturing frames of color data, such as RGB data, using a monocular vision camera. The frames may be video frames, for example. The captured video may come from a variety of sources. In some examples, a camera attached to or integrated with a capturing device, such as user device 110 with camera 111, is used to capture the video. In other examples, a different device or devices may be used to capture the video that are separate from the capturing device. The video may be captured at a previous time, and stored into an appropriate file format that captures the video along with the raw feature points and motion data. Various operations of method 300 may then be performed on the stored video and associated data in post-processing. In one approach, the frames may be captured as a user walks around the 3D space holding the capturing device.

Operation 304 includes selecting key frames. The key frames can be selected from the stream of camera-tracked RGB images, as they become available. For example, as mentioned, a frame can be selected as a key frame when the camera has made a significant movement. In one approach, a set of N key frames is selected, where N=9, for example.

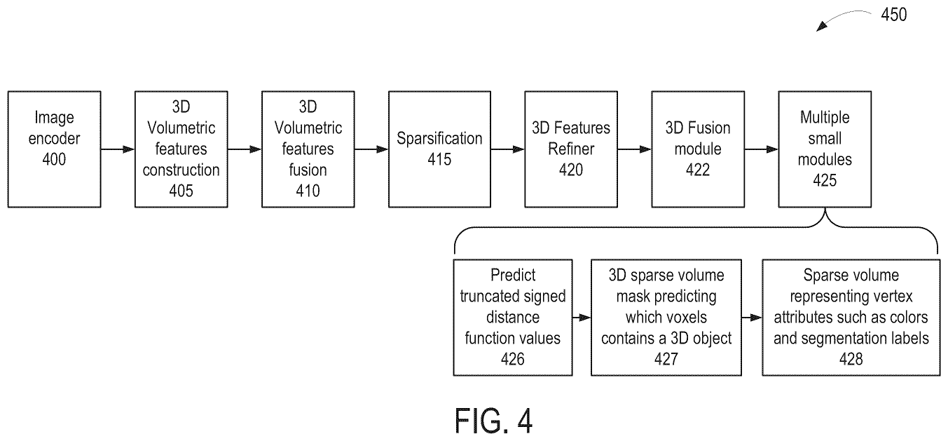

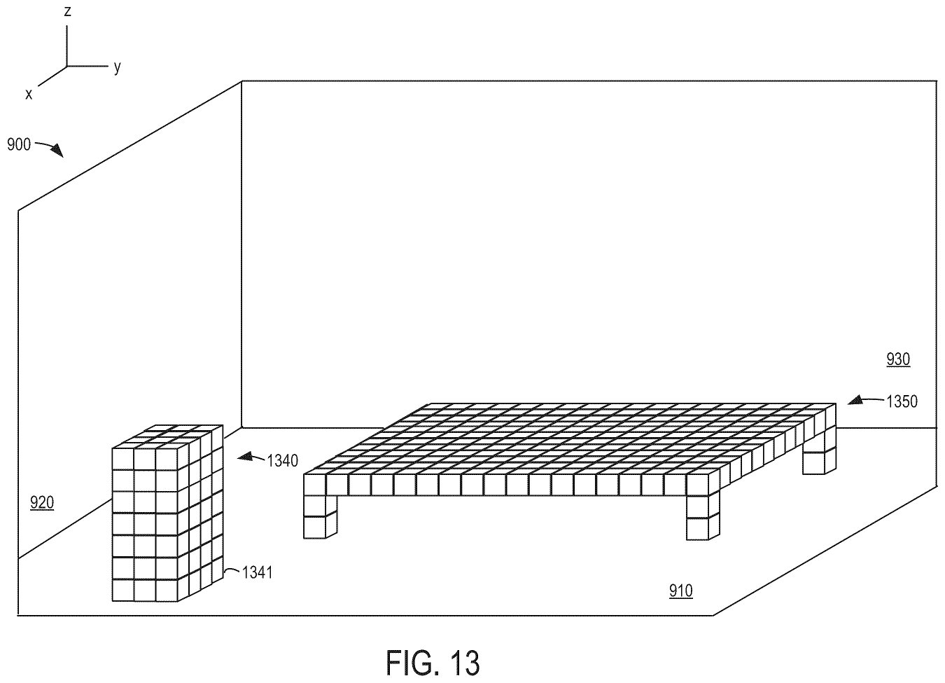

Operation 306 includes processing a set of N key frames to obtain partial 3D scene data, including a mesh model and associated voxels. The partial 3D scene data is for a portion of the scene which is included in the set of key frames. Every set of N key frames (where such a set is referred to as a fragment), is passed to a 3D reconstruction process in a machine learning (ML) model to obtain the partial 3D scene data. This step can involve incrementally creating a mesh model of the 3D scene and defining voxels which encompass points of the mesh model. See FIG. 12B for an example of a mesh model and FIG. 13 for example voxels. See FIG. 4 for example implementation details.

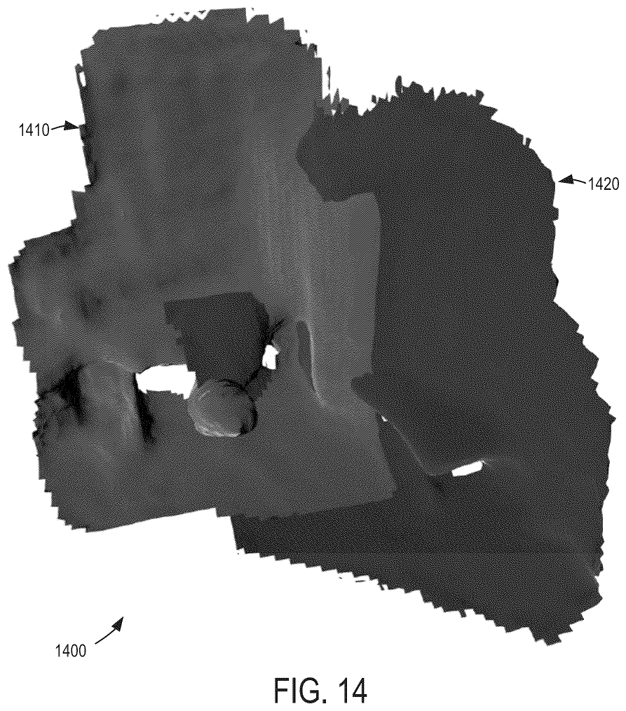

Operation 308 includes fusing the partial 3D scene data into existing scene data which is computed from previous sets of key frames, e.g., fragments. In this way, updated 3D scene data is provided, and the 3D scene can be gradually built up from different sets of key frames. For example, one set of key frames may include one part of an object in a 3D space and another set of key frames may include another part of the object. Or, one set of key frames may include one object in a 3D space and another set of key frames may include another object. See FIG. 14 for an example of fusing of partial 3D scene data.

Operation 310 includes extracting a 3D colored and segmented mesh from the 3D scene data. This mesh can include vertices, faces, vertex colors and vertex segmentation labels, for example. The mesh can be used for visualization or saved for other tasks. A set of voxels can be associated with the vertices such that the colors and segmentation labels are also associated with the voxels.

A decision operation 312 determines whether there is a next set of key frames to process. If the decision operation is true (T), operation 306 is reached. If the decision operation is false (F), the process is done at operation 314. The end of a video sequence is reached.

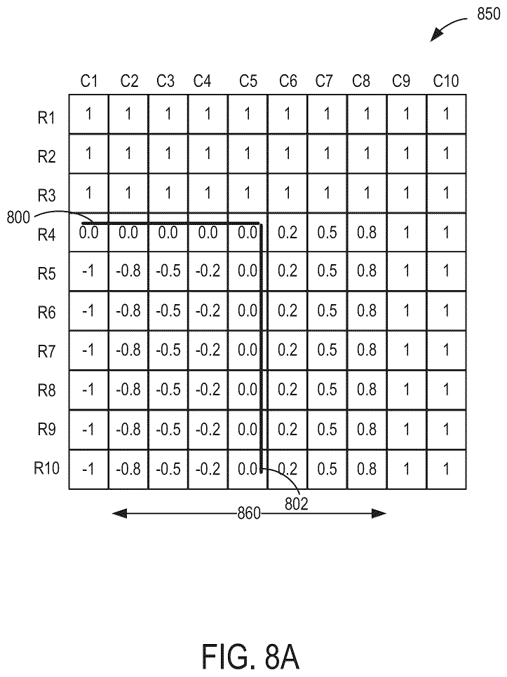

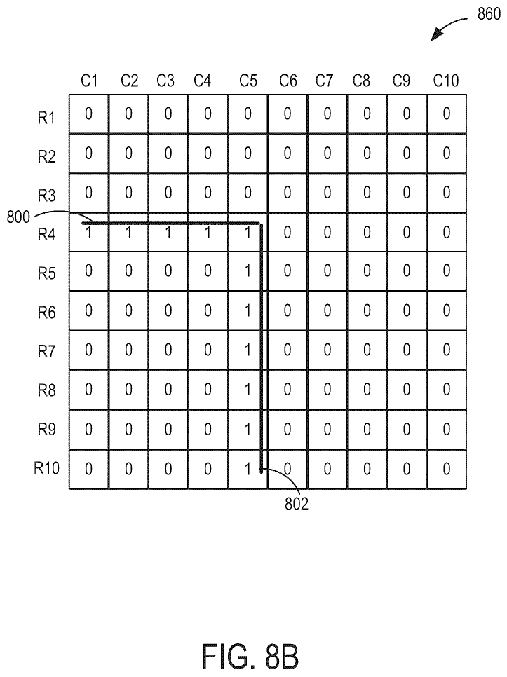

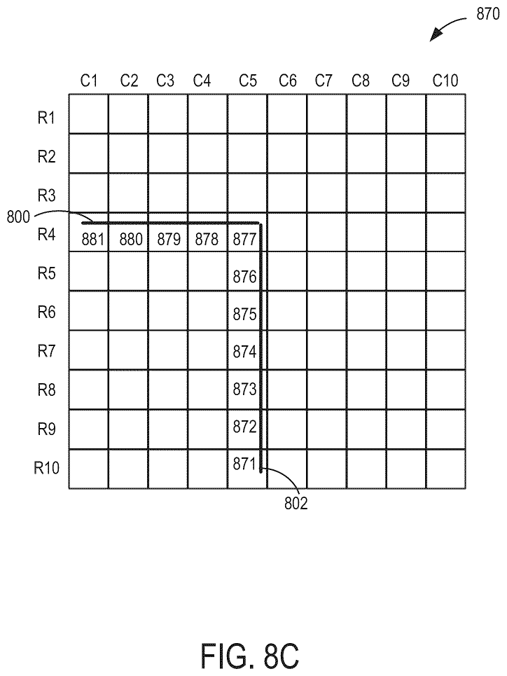

In an example implementation, the process provides outputs including: a sparse 3D volume that keeps, at each voxel, the signed distance to the nearest point on the surface of the scene mesh (FIG. 8A); a sparse 3D masks that keeps, at each voxel, the probability that it belongs to the surface of the mesh (FIG. 8B); and a sparse 3D volume for additional surface attributes such as colors and semantic segmentation labels (FIG. 8C).

Depending upon the capabilities of an implementing system or device, the operations may be performed progressively while the video is being captured, or may be performed on a complete captured video. Note that the frames can be processed in the time order in which they are captured, or in a different order.

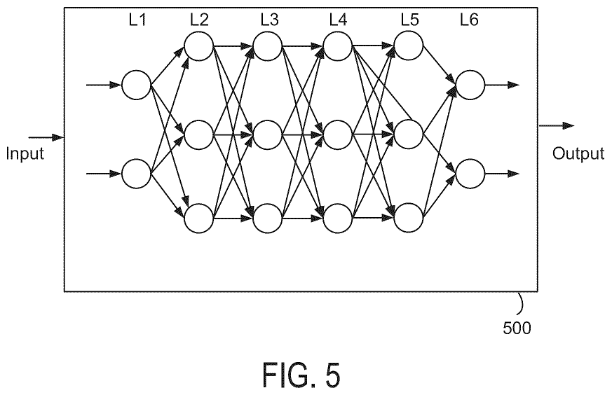

FIG. 4 depicts an example set of modules 450 for implementing operations 306, 308 and 310 of the method of FIG. 3, according to various embodiments. The modules may comprise convolutional neural networks (CNNs), in one possible implementation, such as depicted in FIG. 5. The set of modules therefore includes a set of connected networks. The modules may be arranged in a sequence as indicated where the output data from one module is input to the next module in the sequence. The modules can be implemented by one or more circuits.

An image encoder module 400 extracts 2D features from an image. It computes features from an RGB image at multiple levels of complexity, e.g., low, medium and high. The features can include, e.g., color, shape and texture. Color features can involve, e.g., groups of pixels with similar colors. Shape features can involve, e.g., edges and contours of objects in the 3D space. Texture features can involve, e.g., information about the spatial arrangement of color or intensities in an image or a selected region of an image.

Examples of image classification models which can be used include Resnet or MobileNet. ResNet, or Residual Network, is a Residual Neural Network architecture. This is a pre-trained deep learning model for image classification of a CNN. A CNN is a class of deep neural networks which can be applied to analyzing visual imagery. One example is ResNet-50, which is 50 layers deep and is trained on a million images of 1000 categories from the ImageNet database. MobileNet refers to a class of lightweight deep CNNs. They are small, low-latency, low-power models that can be used for classification, detection, and other common tasks of CNNs. Because of their small size, they are suitable deep learning models on mobile devices, for example.

The modules which follow the image encoder module can operate at each level of the multiple levels of complexity, e.g., low, medium and high.

A 3D Volumetric features construction module 405 uses the camera information attached to each image to unproject the image features from 2D to 3D. Unprojection, also referred to as back projection or inverse projection, refers to reconstruction a 3D scene from a 2D image. When an image of a scene is captured by a camera, depth information is lost since objects and points in 3D space are mapped onto a 2D image plane, in a process referred to as projective transformation.

Unprojection is the inverse of this and involves recovering and reconstructing the scene given only the 2D image. This involves determining a depth of each pixel in the 2D image using techniques such as simultaneous localization and mapping (SLAM) or Structure from Motion (SfM). SLAM is the computational problem of constructing or updating a map of an unknown environment while simultaneously keeping track of the location of an agent, e.g., camera, within it. SfM is a process for estimating the 3D structure of a scene from a set of 2D images. It reconstructs 3D scenes based on feature-point correspondence with consecutive frames or multiple views.

The 3D Volumetric features fusion module 410 aggregates the set of 3D features, computed for each image in the input fragment or set of key frames, into one 3D volume. The aggregation can involve, e.g., averaging or using a transformer network. For example, a set of key frames can be used to create 3D volumetric features. There may be one volumetric feature for each image and a goal is to fuse the volumetric features together.

The sparsification module 415 involves removing unimportant or invalid 3D volumetric features. If multiple levels are used, it only keeps features that are valid at a lower level. A 3D mask in the outputs can be used to determine which features are valid. This block concatenates the selected features at the current level and an upsampling of the features at the lower level.

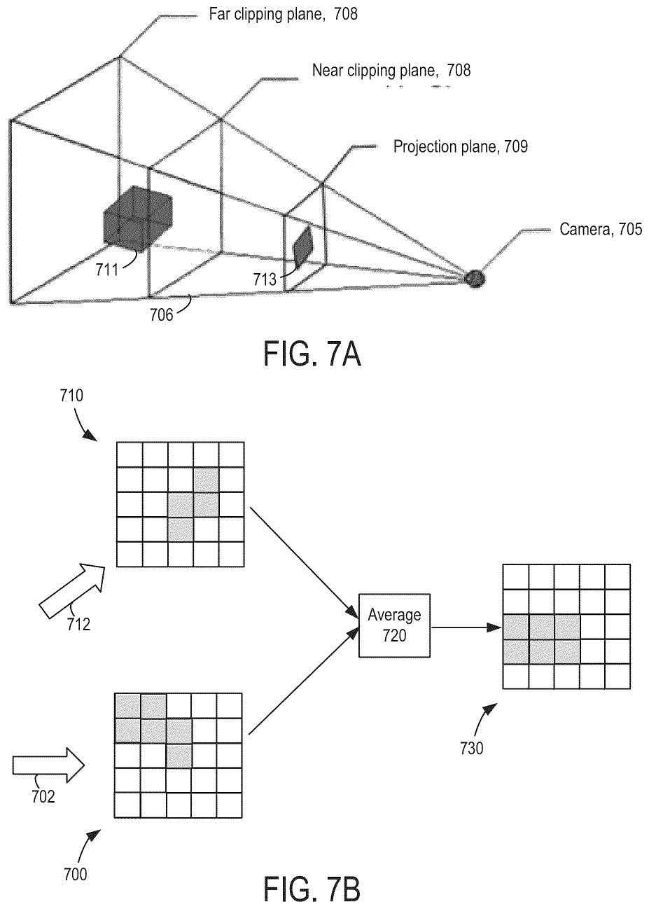

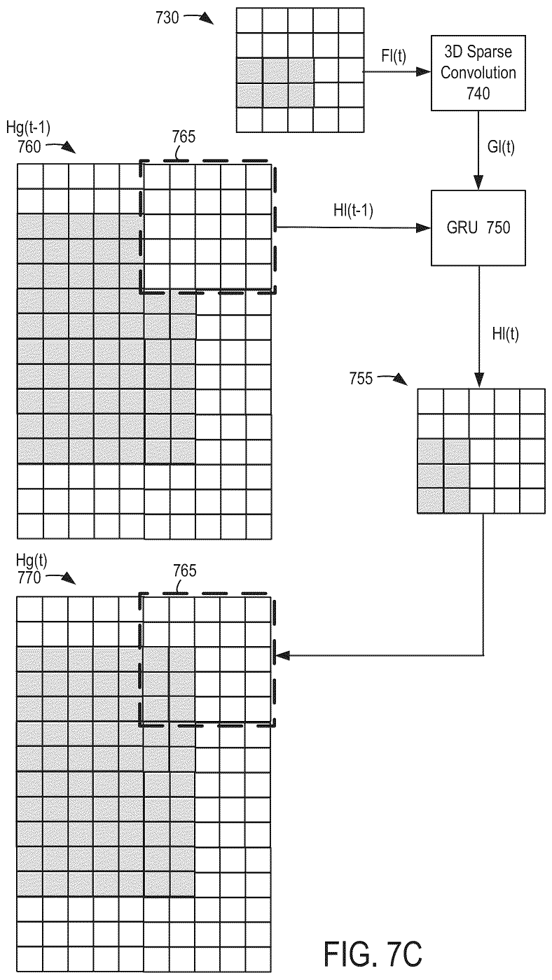

The image encoder gives images features at different resolutions (e.g., coarse, medium, fine). And, for each of these resolutions, the subsequent steps are performed. As shown in FIG. 7C, the results (more specifically the occupancy mask predicted) at the coarse level is used to sparsify the module 405 for the next level (medium), and similarly results at the medium level are used to sparsify the volumes at the fine level, This helps with reducing computational time and memory cost, while preserving fine details in the predicted mesh.

The 3D features refiner module 420 further refines the 3D volumetric features and reduces their dimension so they encompass as much compact information as needed for the multi-heads output, where the heads refer to, e.g., color and semantic segmentation information. This module can include an arbitrary set of voxel attributes that can include colors and semantic labels. See, e.g., example voxels in FIGS. 8A and 13.

A 3D fusion module 422 fuses the outputs from the previous modules, with previously predicted scene data, to ensure that the mesh stays smooth in areas that are seen (and thus predicted) by multiple fragments. See FIG. 14, for example.

The multiple small modules module 425 can include a number of modules such as a truncated signed distance function (TSDF) module 426. This module is for predicting a TSDF, represented as a 3D sparse volume of voxels, to the 3D surface which is to be predicted. See FIG. 8A, for example. A module 427 is for a 3D sparse volume mask predicting which voxels from module 426 contain a 3D object. See FIG. 8B, for example. A module 428 is to provide a sparse volume representing voxel attributes, such as colors and segmentation labels, for the voxels output from module 427. See FIG. 8C, for example. Semantic segmentation labels can label each pixel in an image with a class label. For example, in FIG. 9, the class labels can include bed and cabinet. In one approach, it treats multiple objects of the same class as a single entity. For example, multiple cabinets in a 3D space can be labeled the same as “cabinet.” In another approach, different instances of objects of the same class are labeled separately, e.g., cabinet #1, cabinet #2.

A challenge in adding the multiple small modules module is an increased computational cost, as well as more memory needed to store the extra data. One potential solution is to reduce the batch size during training. Also, data augmentation can be performed on the training data (e.g., varying intervals used to select the key frames, randomly shuffling key frames, image flipping/rotations, etc.) so that the now more complex model does not overfit.

After the features refinement step, there are two Multilayer Perceptron (MLP) modules: one for predicting signed distance and another for occupancy mask. Here, two extra modules are added: one for color prediction (e.g., a 3D vector representing RGB in each voxel of the sparse volume) and another one for segmentation (e.g., for each voxel, a 20D vector representing the probability a voxel belongs to any of the 20 known categories [bed, chair, table, etc.]). Alternatively we could have a single MLP that predicts a 23D vector for each voxel, to predict both colors and segmentation. The actual vector size can vary depending on the number of scene attributes to be predicted.

The modules may process each set of key frames, and this is repeated until the video ends. Overlapping frames help the fusion process. For example, one set of key frames may see one part of an object such as a bed, and another set of key frames may see another part of the bed and also a nearby cabinet.

The modules are initially trained using an input which is a set of key frames, where the output will be sparse volumes where each voxel has attributes including color and segmentation labels. This is essentially training of a machine learning model. It will look at the input and determine what the output should be. The machine learning model undergoes many iterations at test time when it is deployed. The training can be over thousands of videos of different spaces of indoor scenes, for example.

FIG. 5 depicts an example implementation of any of the modules of FIG. 4 as a neural network 500, according to various embodiments. The neural network can be a convolutional neural network, for example. The neural network, also referred to as an artificial neural network, comprises an input layer, one or more hidden layers, and an output layer. Each node, or artificial neuron or processing unit, connects to another node and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. Once trained, they allow for rapid classifying and clustering of data for image recognition tasks, for example.

In this example, each processing unit is represented by a circle, and the arrows between circles represent input paths between the processing units. The layers include, from left to right, an input layer L1, four hidden layers L2-L5 and an output layer L6. The initial data for the neural network is input at the input layer. The hidden layers are intermediate layers (between the input and output layers) where all the computations are performed. The output layer provides a result or output based on the input. Moreover, each processing unit in L2-L5 receives three data inputs. Each input to a processing unit is a data unit of length N bits. The number of processing units per layer can vary. Typically, the hidden layers have the same number of processing units.

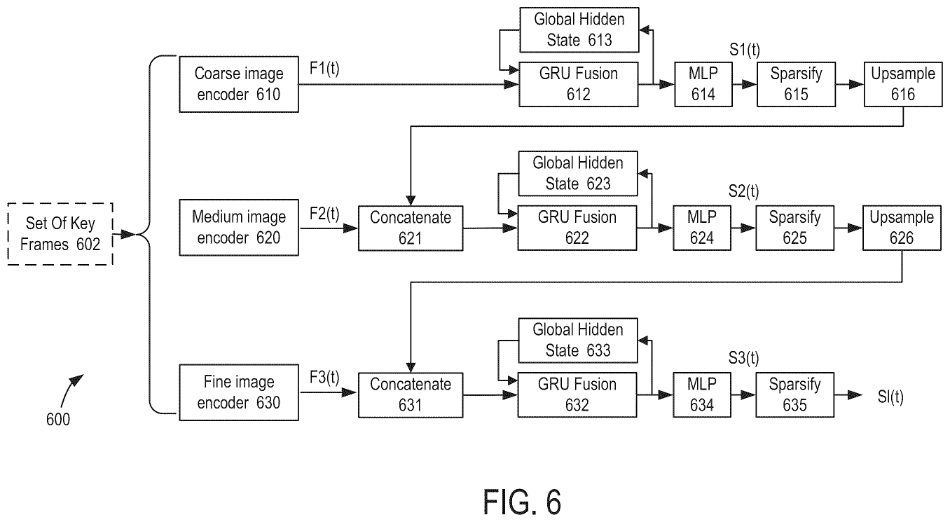

FIG. 6 depicts an example system 600 for implementing some of the modules of FIG. 4, according to various embodiments. The system receives a set of key frames 602 as an input to a coarse image encoder 610, a medium image encoder 620 and a fine image encoder 630. The coarse, medium and fine encoders use large, medium and small voxel sizes, respectively, to provide features with different levels of granularity. Each encoder outputs a respective 3D feature volume F1(t), F2(t) or F3(t). F1(t) is provided to a Gated Recurrent Unit (GRU) Fusion Module 612 which provides an input to, and receives an output from, a Global Hidden State Module 613. A GRU is a gating mechanism in a recurrent neural network. The input to the Global Hidden State Module 613 represents replacement values, and the output from the Global Hidden State Module 613 represents an extracted value.

The output from the GRU Fusion Module 612 is provided to a Multilayer Perceptron (MLP) module 614. MLP is a feedforward artificial neural network that generates a set of outputs from a set of inputs. It is characterized by several layers of input nodes connected as a directed graph between the input and output layers. It uses back propagation to train the network.

The output of the MLP module 614 is S1(t), a dense TSDF volume which is predicted. S1(t) is made sparse by a sparsify function 615 and the sparse output is upsampled at an Upsample Function 616.

The upsampled output is concatenated with F2(t) at a Concatenate Function 621 and the result is provided to the GRU Fusion Module 622. The processing at the modules 622, 623 and 624 and the functions 625 and 626 is similar to the like-named elements discussed above. The output of the MLP module 624 is S2(t), a TSDF volume. S2(t) is made sparse by the sparsify function 625 and the sparse output is upsampled at the Upsample Function 626.

The upsampled output of the Upsample Function 626 is concatenated with F3(t) at a Concatenate Function 631 and the result is provided to the GRU Fusion Module 632. The processing at the modules 632, 633 and 634 and the functions 635 is similar to the like-named elements discussed above. The output of the MLP module 634 is S3(t), a TSDF volume. S3(t) is made sparse by the sparsify function 625 to provide an output SI(t), a sparse TSDF.

Generally, the system predicts a TSDF with a three-level coarse-to-fine approach that gradually increases the density of sparse voxels. Key frame images in the local fragment are first passed through the image backbone to extract the multi-level features. These image features are later back-projected along each ray and aggregated into a 3D feature volume F1(t), where I represents the level index (I-1, 2 or 3). At the first, coarse level (I=1), a dense TSDF volume S1(t) is predicted. At the medium, second and fine, third levels, the upsampled SI-1(t) from the previous level is concatenated with F1(t) and used as the input for the GRU Fusion and MLP modules. A feature volume defined in the world frame is maintained at each level as the global hidden state of the GRU. At the last level, the output SI(t) is used to replace corresponding voxels in a global TSDF volume, resulting in the final reconstruction at time t.

Optionally, after each image encoder, there is a volumetric features extraction step. For instance “Coarse image encoder”->“Coarse 3D features extraction”, “Medium image encoder”->“Medium 3D features extraction”, and “fine image encoder”->“fine 3D features extraction.” Also, note that the global hidden states and GRU Fusion modules can be inserted anywhere along the diagram in alternative implementations, such as between the MLP and Sparsify modules.

FIG. 7A depicts an example implementation of an unprojection process for use in the module 405 of FIG. 4, according to various embodiments. A camera 705 has a field of view 706, where an object 711 is located between a far clipping plane 707 and a near clipping plane 708. The object is unprojected to the projection plane 709 to obtain the unprojected image 713.

FIG. 7B depicts an example of the fusion of multiple sparse volumes extracted from different images in a fragment, consistent with module 410 of FIG. 4, according to various embodiments. In this simplified example, an image volume 700 is obtained when a camera has a viewpoint represented by an arrow 702, and an image volume 710 is obtained when a camera has a viewpoint represented by an arrow 712. Each small box in the image volumes may represent a voxel. The shaded and unshaded portions of the image volumes denote different features. The image volumes are averaged at an averaging function 720 to provide an output image feature volume 730, FI(t), which is used in FIG. 7C.

FIG. 7C depicts an example implementation of a GRU fusion process consistent with FIG. 6 and the output from FIG. 7A, according to various embodiments. The image feature volume 730, F1(t), is passed through a 3D Sparse Convolution Function 740, to extract 3D geometric features, GI(t), which is provided to a GRU module 750. The GRU module also receives the hidden state HI(t−1) which is extracted from a global hidden state Hg(t−1) 760, within a fragment bounding volume 765. The GRU module 750 fuses GI(t) with HI(t−1) to produce an updated hidden state HI(t), represented by the volume 755, which will be passed through the MLP layers to predict the TSDF volume SI(t) at this level. The hidden state HI(t) will also be updated to the global hidden state Hg(t) 770 by directly replacing the corresponding voxels in the fragment bounding volume 765. The bounding volume 765 may have a same size as the image feature volume 730.

FIG. 8A depicts an example of a set of voxels with truncated signed distance function (TSDF) values for use in the module 426 of FIG. 4, according to various embodiments. A TSDF value can be provided for each voxel in a set of voxels 850 to represent a distance of the voxel from an object boundary in a 3D space. The distance can be based on the center of the voxel to the boundary, for instance. A positive value indicates the voxel is in front of the boundary and a negative value indicates the voxel is behind the boundary. This simplified example shows a line 800 as a boundary of a top surface of cabinet 940 of FIG. 9 and a line 802 as a boundary of the front surface of the cabinet.

Each voxel is represented by a cube. The voxels are arranged in rows R1-R10 and columns C1-C10 in this example. The line 800 passes through a set of voxels which are arranged in R4 at C1-C4, and the line 802 passes through a set of voxels which are arranged in C5 at R4-R10. Accordingly, these voxels have a TSDF value of 0.0. The voxels at C6, C7 and C8 have TSDF values of 0.2, 0.5 and 0.8, respectively, at R4-R10. The voxels at C9 and C10 have TSDF values of 1 at R4-R10, since this is the maximum allowed positive distance. The voxels at C4, C3 and C2 have TSDF values of −0.2, −0.5 and −0.8, respectively, at R5-R10. The voxels at C1 have TSDF values of −1 at R5-R10 since this is the maximum allowed negative distance.

The remaining voxels at C1-C10 in R1-R3 have a TSDF value of 1, since they are not behind an object boundary. A truncation distance may be represented by an arrow as +/−3 voxels from the line 802, such that voxels outside this distance are considered to be unoccupied, resulting in the sparse TSDF representation SI(t) of FIG. 6.

FIG. 8B depicts an example of a sparse 3D mask 860 which indicates a probability of whether a voxel belongs to the surface of a mesh, consistent with FIG. 8A, according to various embodiments. Generally, each voxel can store a probability that the voxel belongs to the surface of the mesh. The probability can be a number between 0 (0%) and 1 (100%) which is rounded to 0 or 1 based on a threshold such as 0.50. The probability values can be provided in a sparse 3D mask that keeps, at each voxel, the probability that it belongs to the surface of the mesh. In this example, the voxels which include the lines 800 and 802 in FIG. 8A have a probability of 1 and the remaining voxels have a probability of 0.

FIG. 8C depicts an example of a set of voxels with color and segmentation information, consistent with FIG. 8A, according to various embodiments. The color information for a voxel can be based on the color information from a corresponding portion of each key frame from which the voxel is visible. An average color may be obtained over the set of key frames, for example. For example, assuming the voxels C1-C5 in R4-R10 correspond to the cabinet 940 of FIG. 9, the associated color information will indicate the color of the cabinet.

The segmentation information, as discussed, can label an object as belonging to a class or type of objects. For example, again assuming the voxels C1-C5 in R4-R10 correspond to the cabinet 940 of FIG. 9, the associated segmentation information will label these voxels as belonging to a cabinet.

In one approach, values such as “(0,1,0), 1”, “(1,0,0),0”, etc., can be used in the cells close to the surface boundary, such as cells 871-881. These values represent values for a color (e.g., three floating point values between 0 and 1), and a segmentation index representing a certain category such as a bed.

FIG. 9 depicts an example view of a 3D space 900 for use with the method of FIG. 3, according to various embodiments. The 3D space is a room which includes a floor 910, a back wall 920 and a side wall 930 and objects such as a cabinet 940 and a bed 950. The cabinet is hexahedral. The bed includes a mattress which is generally hexahedral and four post legs. A coordinate system represents x, y and z axes. The view is offset from a central view of the objects.

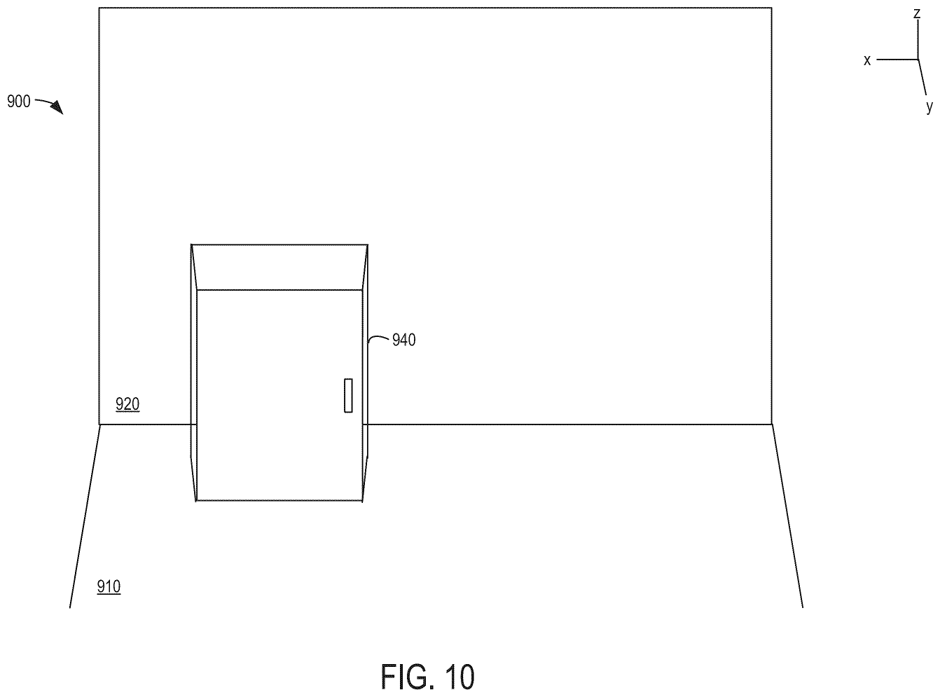

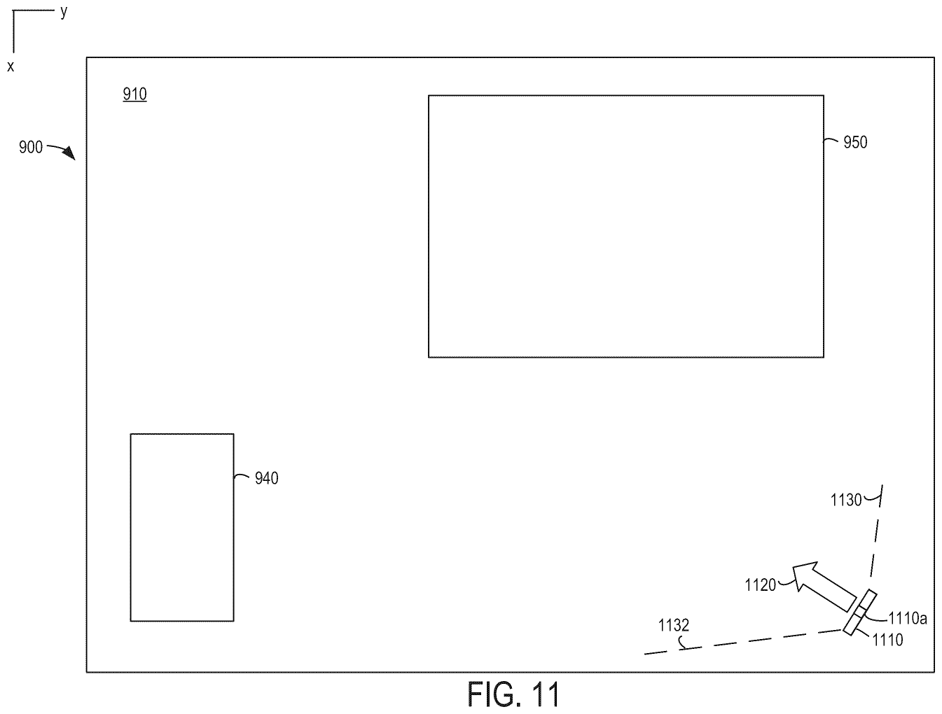

FIG. 10 depicts another example view of the 3D space 900 of FIG. 9, according to various embodiments. The view is from head on and slightly above. The cabinet 940 is depicted here, with the floor 910 and the back wall 920. The viewpoints of FIGS. 9 and 10 are example viewpoints of the object which the capturing device can capture when the user moves the capturing device around the room.

FIG. 11 depicts a top down view of the 3D space 900 of FIG. 9, according to various embodiments. The top down view shows the cabinet 940, bed 950 and floor 910. A camera 1110 with a lens 1110a is also depicted. The camera has a forward looking vector 1120, which is the direction in which the camera is looking. Afield of view of the camera is represented by dashed lines 1130 and 1132.

FIG. 12A depicts example sparse 3D point clouds 1240 and 1250 consistent with the view of FIG. 9, according to various embodiments. Each point of a point cloud is represented by a black circle. Typically, a depth value is determined for each pixel in a frame, where there are multiple rows of pixels. A sparse 3D point cloud is obtained by down sampling, such as by using every fifth or tenth pixel in each row of a frame and/or by using every fifth or tenth row in a frame. The points extend in uniform rows and columns as a simplification. The point clouds 1240 and 1250 represent the cabinet 940 and the bed 950, respectively. The points extend along the surfaces of the cabinet and the bed which are visible in the current perspective, in the field of view of the capturing device.

The points can be used to generate a 3D mesh model of the objects. In one approach, the points are connected to form triangles, where the points are vertices of the triangles. Each triangle is a face which represents a portion of the surface of an object. For example, the portion 1241 of the point cloud 1240 can be used to form a portion of a mesh model as depicted in FIG. 12B. One possible method for generating a mesh from a 3D volume such as the ones predicted here is called “marching cubes”.

Note that separate point clouds are depicted for the cabinet and bed but, in practice, a single continuous point cloud may be obtained which identifies all surfaces in the 3D space including the floor and the walls.

FIG. 12B depicts an example mesh model 1242 corresponding to the portion 1241 of the sparse 3D point cloud 1240 of FIG. 12A, according to various embodiments. A point cloud may be processed to generate a 3D mesh, such as by repeatedly connecting each of the points in the point cloud into groups of three to form a mesh of triangles. Each of the points then becomes a vertex for one or more triangles, with edges of the various triangles formed by the connection between two adjacent points.

In this example, the mesh model include nine points or vertices, including an example vertex 1244, which form eight triangles, including an example triangle 1245. The mesh model can be built up over time from the points of key frames.

FIG. 13 depicts example sets of voxels 1340 and 1350 which encompass the points of the sparse 3D point clouds 1240 and 1250 of FIG. 12A, respectively, according to various embodiments. An example individual voxel 1341 is depicted. Voxels are volumes which encompass the points of the point clouds and therefore conform to the boundaries of the objects in the 3D space. The voxels can also store information such as depth, camera viewing angle, color information and semantic segmentation information. The voxels can be uniformly size cubes, in one approach, and be arranged in rows and columns. The voxels may be a few centimeters in length, e.g., 2-5 cm, on each side.

Generally, the voxels are sized such that one or more points fall within each voxel. Each voxel can be represented by a single point. When multiple points fall within a voxel, the single representative point can be determined, e.g., by averaging.

The voxels represent a sparse 3D volume, where only those voxels which contain information regarding part of a surface of an object are kept.

FIG. 14 depicts the combining or fusing of two fragments 1410 and 1420 which represent two areas of a 3D space, consistent with the module 422 of FIG. 4, according to various embodiments. Each fragment represents a portion of a 3D space, and the combination of the fragments provides a reconstruction of a larger portion 1400 of the physical scene.

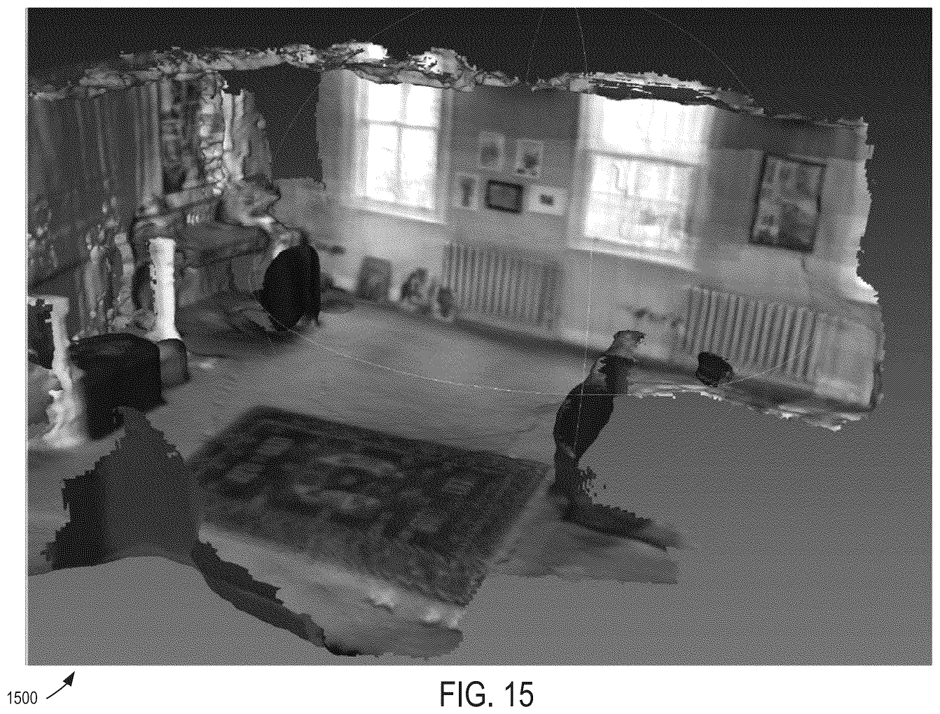

FIG. 15 depicts a fully reconstructed image 1500 of a 3D space, according to various embodiments. The image depicts a room in a home, including objects such as a desk, chair, rug, heating radiators, windows and wall hangings.

FIG. 16 illustrates an example computer device 1600 that may be employed by the apparatuses and/or methods described herein, in accordance with various embodiments. As shown, computer device 1600 may include a number of components, such as one or more processor(s) 1604 (one shown) and at least one communication chip 1606. In various embodiments, one or more processor(s) 1604 each may include one or more processor cores. In various embodiments, the one or more processor(s) 1604 may include hardware accelerators to complement the one or more processor cores. In various embodiments, the at least one communication chip 1606 may be physically and electrically coupled to the one or more processor(s) 1604. In further implementations, the communication chip 1606 may be part of the one or more processor(s) 1604. In various embodiments, computer device 1600 may include printed circuit board (PCB) 1602. For these embodiments, the one or more processor(s) 1604 and communication chip 1606 may be disposed thereon. In alternate embodiments, the various components may be coupled without the employment of PCB 1602.

Depending on its applications, computer device 1600 may include other components that may be physically and electrically coupled to the PCB 1602. These other components may include, but are not limited to, memory controller 1626, volatile memory (e.g., dynamic random access memory (DRAM) 1620), non-volatile memory such as read only memory (ROM) 1624, flash memory 1622, storage device 1654 (e.g., a hard-disk drive (HDD)), an 1/O controller 1641, a digital signal processor (not shown), a crypto processor (not shown), a graphics processor 1630, one or more antennae 1628, a display, a touch screen display 1632, a touch screen controller 1446, a battery 1636, an audio codec (not shown), a video codec (not shown), a global positioning system (GPS) device 1640, a compass 1642, an accelerometer (not shown), a gyroscope (not shown), a speaker 1650, a camera 1652, and a mass storage device (such as hard disk drive, a solid state drive, compact disk (CD), digital versatile disk (DVD)) (not shown), and so forth.

In some embodiments, the one or more processor(s) 1604, flash memory 1622, and/or storage device 1654 may include associated firmware (not shown) storing programming instructions configured to enable computer device 1600, in response to execution of the programming instructions by one or more processor(s) 1604, to practice all or selected aspects of process flow 200 or method 300 as described herein. In various embodiments, these aspects may additionally or alternatively be implemented using hardware separate from the one or more processor(s) 1604, flash memory 1622, or storage device 1654.

The communication chips 1606 may enable wired and/or wireless communications for the transfer of data to and from the computer device 1600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1606 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1600 may include a plurality of communication chips 1606. For instance, a first communication chip 1606 may be dedicated to shorter range wireless communications such as Wi-Fi and Bluetooth, and a second communication chip 1606 may be dedicated to longer range wireless communications such as GPS, EDGE, GPRS, CDMA, WiMAX, LTE, Ev-DO, and others.

In various implementations, the computer device 1600 may be a laptop, a netbook, a notebook, an ultrabook, a smartphone, a computer tablet, a personal digital assistant (PDA), a desktop computer, smart glasses, or a server. In further implementations, the computer device 1600 may be any other electronic device or circuit that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

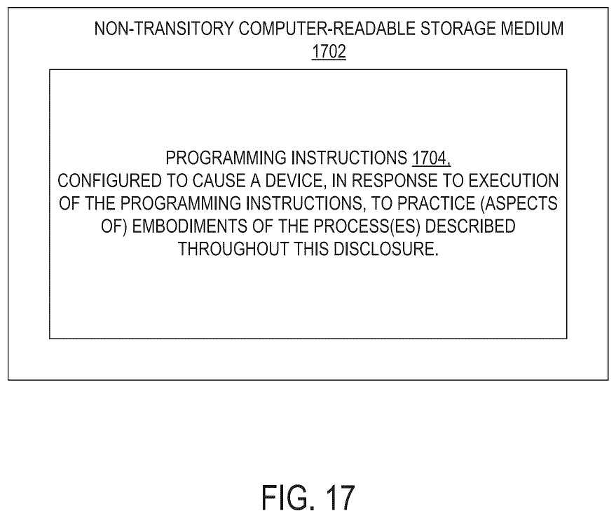

FIG. 17 illustrates an example computer-readable non-transitory storage medium that may be suitable for use to store instructions that cause an apparatus, e.g., a processor or other circuit, in response to execution of the instructions by the apparatus, to practice selected aspects of the present disclosure. As shown, non-transitory computer-readable storage medium 1702 may include a number of programming instructions 1504. Programming instructions 1704 may be configured to enable a device, e.g., computer 1600, in response to execution of the programming instructions, to implement (aspects of) process flow 200 and method 300 as described above. In alternate embodiments, programming instructions 1704 may be disposed on multiple computer-readable non-transitory storage media 1702 instead. In still other embodiments, programming instructions 1704 may be disposed on computer-readable transitory storage media 1702, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways.

This application is intended to cover any adaptations or variations of the embodiments discussed herein. Therefore, it is manifestly intended that embodiments be limited only by the claims and the equivalents thereof.

What is claimed is:

1. A method, comprising:
receiving, from a monocular vision camera, a plurality of frames of color data;
processing a set of key frames from the plurality of frames to obtain partial 3D scene data;
fusing the partial 3D scene data into existing 3D scene data computed from one or more previous sets of key frames, to provide updated 3D scene data; and
extracting color and segmentation data from the updated 3D scene data.

2. The method of claim 1, wherein the processing the set of key frames comprises inputting the set of key frames to a sequence of modules comprising neural networks.

3. The method of claim 2, wherein the sequence of modules comprise:
one or more image encoders to obtain image features from the set of key frames;
a 3D volumetric features construction module to unproject the image features;
a 3D volumetric features fusion module to create 3D volumetric features;
a sparsification module to remove invalid 3D volumetric features; and
a 3D features refiner module to refine the 3D volumetric features and reduce their dimension.

4. The method of claim 3, wherein the sequence of modules further comprise, following the 3D features refiner module, a 3D fusion module to fuse outputs from previous modules in the sequence of modules with previously predicted scene data.

5. The method of claim 2, wherein the sequence of modules further comprise, following the 3D features refiner module, a module to predict a truncated signed distance function (TSDF), represented as a 3D sparse volume of voxels.

6. The method of claim 5, wherein the sequence of modules further comprise, following the module to predict the TSDF, a module to predict which voxels contain a 3D object.

7. The method of claim 6, wherein the sequence of modules further comprise, following the module to predict which voxels contain the 3D object, a module to provide a sparse volume representing attributes of the voxels.

8. The method of claim 7, wherein the attributes comprise colors and segmentation labels.

9. A non-transitory computer readable medium (CRM) comprising instructions that, when executed by an apparatus, cause the apparatus to:
receive, from a monocular vision camera, a plurality of frames of color data of a scene;
obtain image features from a set of key frames;
unproject the image features to reconstruct the scene;
create 3D volumetric features from the reconstructed scene;
predict a truncated signed distance function (TSDF), represented as a 3D sparse volume of voxels, for a surface in the reconstructed scene;
predict which voxels contain a 3D object; and
provide a sparse volume representing attributes of the voxels which contain the 3D object, wherein the attributes comprise colors.

10. The CRM of claim 9, wherein the attributes comprise segmentation labels.

11. The CRM of claim 9, wherein the instructions, when executed by the apparatus, further cause the apparatus to:
remove invalid 3D volumetric features of the created 3D volumetric features; and
refine the 3D volumetric features.

12. The CRM of claim 9, wherein to obtain the image features, the instructions, when executed by the apparatus, further cause the apparatus to obtain coarse, medium and fine image features with large, medium and small voxel sizes, respectively.

13. A system, comprising:
a server with a processor; and
a storage device in communication with the server, wherein the storage device includes instructions that, when executed by the processor, cause the server to:
receive, from a monocular vision camera, a plurality of frames of color data;
process a set of key frames from the plurality of frames to obtain partial 3D scene data;
fuse the partial 3D scene data into existing 3D scene data computed from one or more previous sets of key frames, to provide updated 3D scene data; and
extract color and segmentation data from the updated 3D scene data.

14. The system of claim 13, wherein to process the set of key frames, the instructions, when executed by the processor, further cause the processor to input the set of key frames to a sequence of modules comprising neural networks.

15. The system of claim 14, wherein the sequence of modules comprise:
one or more image encoders to obtain image features from the set of key frames;
a 3D volumetric features construction module to unproject the image features to reconstruct a scene;
a 3D volumetric features fusion module to create 3D volumetric features from the reconstructed scene;
a sparsification module to remove invalid 3D volumetric features; and
a 3D features refiner module to refine the 3D volumetric features and reduce their dimension.

16. The system of claim 14, wherein the sequence of modules further comprise, following the 3D features refiner module, a module to predict a truncated signed distance function (TSDF), represented as a 3D sparse volume of voxels.

17. The system of claim 16, wherein the sequence of modules further comprise, following the module to predict the TSDF, a module to predict which voxels contain a 3D object.

18. The system of claim 17, wherein the sequence of modules further comprise, following the module to predict which voxels contain the 3D object, a module to provide a sparse volume representing attributes of the voxels.

19. The system of claim 18, wherein the attributes comprise colors and segmentation labels.

20. The system of claim 16, wherein the sequence of modules further comprise, after the 3D features refiner module, and before the module to predict the TSDF, a 3D fusion module to fuse outputs from previous modules in the sequence of modules with previously predicted scene data.
